(19) United States
(12) Patent Application Publication
(10) Pub. No.: US 2024/0281655 A1
(43) Pub. Date: Aug. 22, 2024

(54) RAPID ESTIMATION OF THE UNCERTAINTY OF THE OUTPUT OF A NEURAL TASK NETWORK

(71) Applicant: Robert Bosch GmbH, Stuttgart (DE)

(72) Inventors: Lydia Gauerhof, Sindelfingen (DE); Bangyu Zhu, Leonberg (DE); Christoph Schorn, Benningen Am Neckar (DE)

(21) Appl. No.: 18/443,711

(22) Filed: Feb. 16, 2024

(30) Foreign Application Priority Data
Feb. 22, 2023 (DE) 10 2023 201 583.8

(51) Int. Cl. G06N 3/08

(52) U.S. Cl. CPC G06N 3/08

(57) ABSTRACT

A method for training a measurement network which ascertains the uncertainty of an already trained task network. In the method: each training record of measurement data from a training data set is fed to a plurality of modifications of a deterministic task network, or fed multiple times to a probabilistic task network, and thus mapped onto a plurality of outputs; each training record is fed to the measurement network and mapped onto a prediction of the distribution of the plurality of outputs, wherein the processing chain of the measurement network includes a part of the processing chain of the task network; a predefined cost function evaluates the extent to which the prediction of the distribution is consistent with the outputs; and network parameters which characterize the behavior of that part of the measurement network that does not belong to the processing chain of the task network are optimized.

### CROSS REFERENCE

The present application claims the benefit under 35 U.S.C. § 119 of German Patent Application No. DE 10 2023 201 583.8 filed on Feb. 22, 2023, which is expressly incorporated herein by reference in its entirety.

### FIELD

The present invention relates to the monitoring of the operation of neural networks that process the input records of measurement data into outputs with regard to a predefined task.

### BACKGROUND INFORMATION

Neural networks are often used for evaluating measurement data, such as images or radar data from the surroundings of at least partially automated vehicles. Like a human driver, these networks can be trained with a finite number of scenarios, and then generalize to a large number of scenarios not seen in the training. They map input measurement data onto outputs with regard to a predefined task and are therefore also called task networks.

It can be important, in particular for safety-critical applications, to also capture the uncertainty of the outputs supplied by the task network. This is analogous to the fact that, when ascertaining physical variables, a detailed error calculation is often carried out which, starting from the measurement uncertainties of the directly measurable variables, ascertains the possible error in the sought variable derived therefrom.

### SUMMARY

The present invention provides a method for training a measurement network which ascertains the uncertainty of an already trained task network during the processing of a record of measurement data into outputs with regard to a predefined task.

The method uses training records of measurement data from a training data set. In this connection, the terms “record” and “data set” are used in accordance with common usage in the field of machine learning. A record is a data structure with associated measurement data and is in this respect comparable to an index card in a card index box, which also contains data associated therewith. A data set is a set of many records and in this respect comparable to a card index box filled with index cards.

The training data set used within the context of this method does not have to be the training data set which was used for the monitored training of the task network for solving the predefined task. The training data set can in particular comprise unlabeled measurement data for which no target outputs of the task network are known. There is generally no shortage of unlabeled measurement data, while labeling measurement data can account for the largest share of the costs associated with the introduction of a machine learning process.

According to an example embodiment of the present invention, with the aid of the trained task network, each training record of measurement data from the training dataset is mapped onto a plurality of different outputs of the task network. This can be done in two ways. If the task network is a deterministic network which always provides the same result when identical data are repeatedly input, the training record can be fed to a plurality of modifications of this deterministic task network. If the task network is a probabilistic network whose processing chain contains pulling a sample from a distribution at at least one point, the training record can be fed to this probabilistic network multiple times.

According to an example embodiment of the present invention, the training record of measurement data is also fed to the measurement network to be trained and mapped onto a prediction of the distribution of the plurality of outputs. In this case, the processing chain of the measurement network comprises a part of the processing chain of the task network. That is to say, in one part of the measurement network, data are processed in the same way as in the corresponding part of the task network. The measurement network can in particular, for example, reuse intermediate results that have already been worked out by the task network during the generation of the plurality of outputs, and in this way save computing effort. For example, a single network that produces the intermediate results can
on the one hand, feed into a task header, which forms the outputs of the task network, and
on the other hand, feed into a measurement header, which forms the prediction of the distribution.

A predefined cost function evaluates the extent to which the prediction of the distribution is consistent with the plurality of outputs. For example, a check can be made as to the extent to which the plurality of outputs belong to the predicted distribution. However, from the plurality of outputs a distribution, for example, to which this plurality of outputs most likely belongs can also be ascertained, and this distribution can be compared with the predicted distribution.

Network parameters that characterize the behavior of that part of the measurement network that does not belong to the processing chain of the task network are optimized with the aim of the evaluation being improved by the cost function during further processing of training records. However, parameters that characterize the behavior of the part of the measurement network belonging to the processing chain of the task network remain frozen, so that the behavior of the task network is not changed.

If the measurement network has been trained in this way, it will be able to predict the distribution of the plurality of outputs supplied by the task network significantly faster than the task network can deliver these itself. This distribution is decisive for the uncertainty being sought in the processing of a record of measurement data. The measurement network only has to run through once in the forward direction and thereby also reuses intermediate results from the task network, so that the additional effort is very low compared to the execution of the task network that is required anyway.

If, on the other hand, for example, the plurality of outputs of the task network is ascertained by the execution of multiple modifications of the task network, these modifications will be run through in the forward direction in the order of magnitude of 30-50 runs. In this case, the modifications are typically to a great extent identical, so that a certain proportion of the results can be used several times. Nevertheless, the generation of 30-50 outputs by modifications of the task network still takes about ten times as long as the generation of only one output by the task network. This is too slow for monitoring the functioning of the task network in real time, for example when using the task network for controlling a vehicle or robot.

The trained measurement network thus provides a possibility for such real-time monitoring. The prediction of the distribution of the plurality of outputs that is decisive for the uncertainty may not be 100% accurate, but it is performed rapidly enough.

In a particularly advantageous embodiment of the present invention, a convolutional neural network with one or more convolutional layers that process their input by sliding application of one or more filter kernels to feature maps is selected as task network. The measurement network processes one or more of these feature maps into the prediction of the distribution. Within the processing chain of the measurement network, the part that also belongs to the processing chain of the task network thus stands at the beginning. The additional effort for ascertaining the prediction for the distribution is thus minimized.

The measurement network can, in particular, comprise a plurality of sub-networks, for example, which process different feature maps or combinations of feature maps. In this way, features extracted from the record of measurement data can be analyzed, in particular, for example on different size scales.

In a particularly advantageous embodiment of the present invention, a deterministic task network is selected. The modifications of this task network are then selected in such a way that they leave unchanged that part of the task network that is contained in the processing chain of the measurement network.

In this way, the part of the task network which is also part of the measurement network only needs to be run through once.

In a further particularly advantageous embodiment of the present invention, the modifications of the task network are generated by deactivating a randomly drawn selection of neurons or other processing units of the task network. This “Monte Carlo dropout” is the “gold standard” for determining the uncertainty of outputs of the task network, but, as explained above, requires a lot of time. The trained measurement network provides an approximation of this “gold standard” in a significantly shorter time.

In a further particularly advantageous embodiment of the present invention, a predefined distribution function whose behavior is characterized by distribution parameters is adapted to the plurality of outputs by optimizing the distribution parameters. The measurement network ascertains a prediction of these distribution parameters. In this way, prior knowledge regarding the distribution function can be introduced.

In particular, a Dirichlet distribution can be selected as a distribution function, for example. The sought uncertainty of the output of the task network is immediately apparent from the entropy of this Dirichlet distribution. The entropy is at the same time an adjustable parameter of the Dirichlet distribution.

In a further particularly advantageous embodiment of the present invention, records of measurement data are fed to the trained measurement network. The sought uncertainty in the processing of the respective record is ascertained from the prediction of the distribution provided by the measurement network. As explained above, in this way the operation of the task network can be monitored in real time.

The uncertainty sought can be ascertained in particular, for example, from at least one distribution parameter and/or from at least one statistical characteristic variable, the distribution predicted by the measurement network. However, it can also be ascertained, for example, using a plurality of samples drawn from the distribution predicted by the measurement network.

According to an example embodiment of the present invention, in response to the ascertained uncertainty meeting a predefined criterion (such as exceeding a threshold value), various measures can be taken in order to improve the training of the task network and/or the operation of a technical system controlled using outputs of the task network.

For example, the record can be selected from measurement data for the initial labeling or for the re-labeling with a target output. An increased uncertainty can thus be assessed as a sign that by the current state of training the record is not sufficiently covered by measurement data. An “active learning” can thus be realized in which those records with target task outputs are always labeled as “ground truth,” for which this promises the greatest profit in terms of further training. This is in particular advantageous when labeling is particularly complex and/or expensive. For example, if a neural network is used to deduce quality features in the interior of a workpiece or manufactured product from observations accessible from the outside, “ground truth” will only be obtainable by sawing through the workpiece or product and examining it metallurgically. In the assessment of images in the context of medical imaging, “ground truth” may be obtained only by a human expert who examines the images.

For example, the output ascertained by the task network for the record in question can also be discarded. In many applications, it is not essential that an output of the task network in fact has to be available at all times. In a case of doubt, a missing output can be better than an incorrect output.

For example, a technical system that uses the output supplied by the task network can also be controlled to the effect that disadvantageous consequences of incorrect outputs are avoided. The system can thus be prepared to a certain extent such that there is great uncertainty regarding certain records of measurement data.

This is the case in particular for vehicles and/or robots as technical systems that are controlled in real time using outputs of the task network.

For example, at least one additional physical sensor can be activated for the observation of the surroundings of the robot and/or vehicle. If, for example, the evaluation of a camera image is uncertain, because the low-lying sun is shining fully on the image sensor and driving the image sensor into saturation, the additional use of a radar sensor can be helpful in evaluating the situation.

For example, the travel speed of an at least partially automated robot and/or vehicle can also be reduced. In this way, the reaction time available in the event of problems is increased and at the same time possible damage due to the lower impact energy is reduced.

For example, a driver assistance system and/or a system for the at least partially automated guidance of the robot and/or vehicle can also be completely or partially deactivated, so that only basic functions are then available or control is even completely transferred to a human driver.

In the last escalation stage, a robot or an at least partially automated vehicle can finally be brought to a standstill on a pre-planned emergency stop trajectory.

In a further particularly advantageous embodiment of the present invention, an image classifier which maps an input image as a record of measurement data onto classification scores with respect to one or more classes of a predefined classification is selected as task network. The classification scores supplied by an image classifier can relate to the image as a whole, but also, for example, to individual pixels of the image, so that semantic segmentation of the image then arises. Some image classifiers, such as a YOLOv5 network, can additionally detect a so-called “objectness” for each pixel, which indicates whether this pixel belongs to an object or to the image background. In conjunction with a spatially resolved detection of the uncertainty, the object can be used to prefilter the uncertainty.

The task network can, for example, be supplemented with an anomaly detector network, such as a FACER network (Feature Activation Consistency checkER), to the measurement network.

According to an example embodiment of the present invention, the method can in particular be wholly or partially computer-implemented. The present invention therefore also relates to a computer program comprising machine-readable instructions that, when executed on one or more computers and/or compute instances, cause the computer(s) and/or compute instances to execute the described method of the present invention. In this sense, control devices for vehicles and embedded systems for technical devices, which are also capable of executing machine-readable instructions, are to be regarded as computers. Compute instances can be virtual machines, containers or serverless execution environments, for example, which can be provided in a cloud in particular.

The present invention also relates to a machine-readable data carrier and/or to a download product comprising the computer program of the present invention. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product, according to the present invention.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of a method 100 for training a measurement network 2 according to the present invention.

FIG. 2 shows an illustration of the training of the measurement network 2, according to an example embodiment of the present invention.

FIG. 3 shows an illustration of the further use of feature maps 11-16 formed by the task network 1, according to an example embodiment of the present invention.

### DETAILED DESCRIPTION OF EXAMPLE EMBODIMENTS

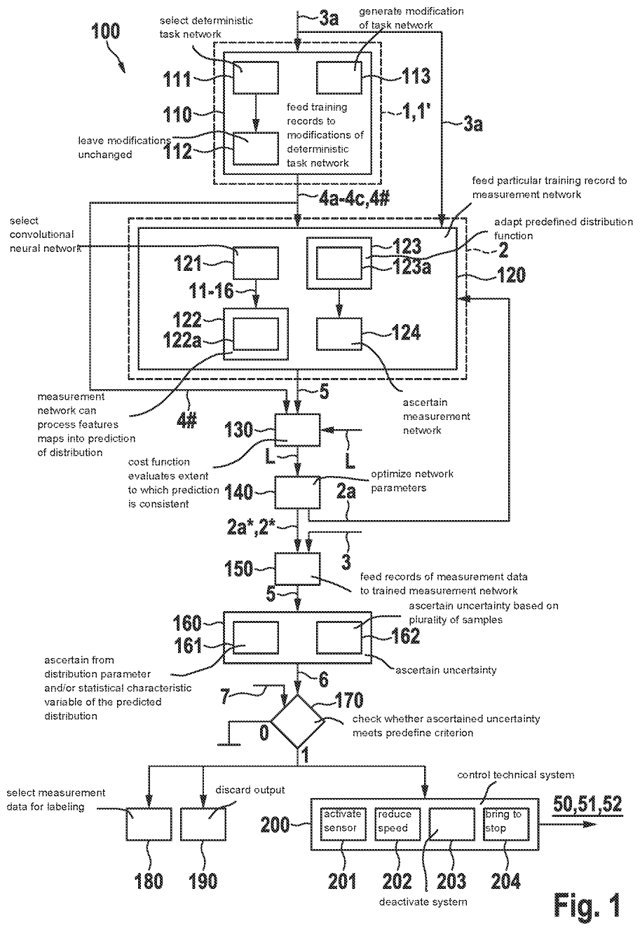

FIG. 1 is a schematic flow chart of an exemplary embodiment of the method 100 for training a measurement network 2. The purpose of this measurement network 2 is to ascertain the uncertainty of an already trained task network 1 during the processing of a record 3 of measurement data into outputs 4 with regard to a predefined task.

In step 110, each training record 3a of measurement data from a training data set is fed to a plurality of modifications 1′ of a deterministic task network 1, or fed multiple times to a probabilistic task network 1, and in this way mapped onto a plurality of outputs 4a-4c. These outputs 4a-4c form a distribution 4 #.

In step 120, the particular training record 3a is fed to the measurement network 2 and mapped onto a prediction 5 of the distribution 4 #of the plurality of outputs 4a-4c, wherein the processing chain of the measurement network 2 comprises a part of the processing chain of the task network 1.

According to block 111, a deterministic task network 1 can be selected. According to block 112, the modifications 1′ of this task network 1 can then leave unchanged that part of the task network 1 which is contained in the processing chain of the measurement network 2.

According to block 113, the modifications 1′ of the task network 1 can be generated by deactivating a randomly drawn selection of neurons or other processing units of the task network 1.

According to block 121, a convolutional neural network with one or more convolutional layers that process their input by sliding application of one or more filter kernels to feature maps 11-16 can be selected as task network 1. According to block 122, the measurement network 2 can then process one or more of these feature maps 11-16 into the prediction 5 of the distribution 4 #.

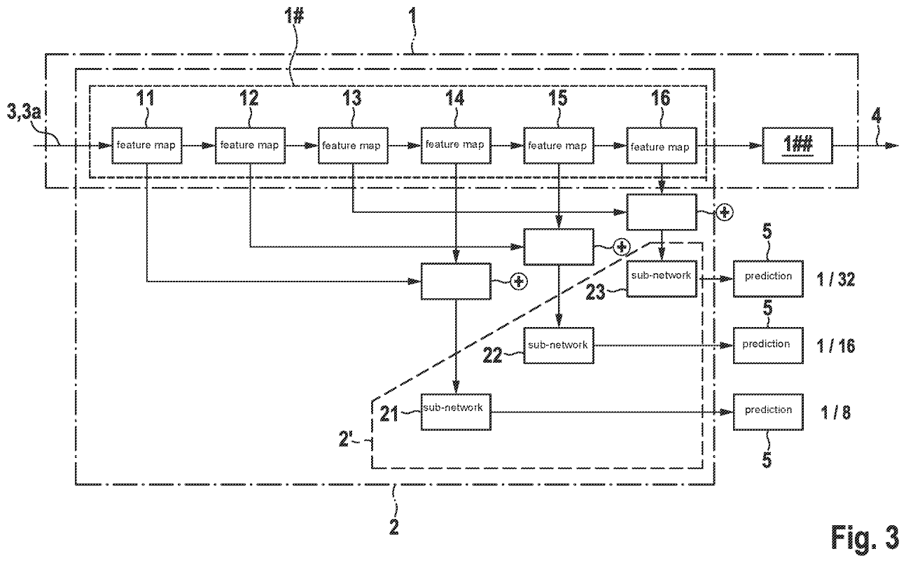

According to block 122a, the measurement network 2 can comprise a plurality of sub-networks 21-23 which process different feature maps 11-16 or combinations of feature maps 11-16. This is shown in more detail in FIG. 3.

According to block 123, a predefined distribution function 4 #, whose behavior is characterized by distribution parameters, can be adapted by optimizing the distribution parameters to the plurality of outputs 4a-4c. According to block 124, the measurement network 2 can then ascertain a prediction 5 of these distribution parameters.

According to block 123a, a Dirichlet distribution can in particular, for example, be selected as a distribution function 4 #.

In step 130, a predefined cost function L evaluates the extent to which the prediction 5 of the distribution 4 #is consistent with the plurality of outputs 4a-4c.

In step 140, network parameters 2a that characterize the behavior of that part of the measurement network 2 that does not belong to the processing chain of the task network 1 are optimized with the aim of the evaluation being improved by the cost function L during further processing of training records 3a. The fully optimized state of the network parameters 2a is denoted by the reference sign 2a*. These network parameters 2a* define the trained state 2* of the measurement network 2.

In step 150, records 3 of measurement data are fed to the trained measurement network 2*. The result is the prediction 5 of the distribution 4 #.

In step 160, the sought uncertainty 6 is ascertained from the prediction 5 of the distribution 4 #supplied for a record 3 by the measurement network 2* during the processing of this record 3.

According to block 161, the uncertainty 6 can be ascertained from at least one distribution parameter and/or from at least one statistical characteristic variable of the distribution 5 predicted by the measurement network 2*.

According to block 162, the uncertainty 6 can be ascertained on the basis of a plurality of samples drawn from the distribution 5 predicted by the measurement network 2.

In step 170, a check is made as to whether the ascertained uncertainty meets a predefined criterion 7. If this is the case (truth value 1), various measures can be taken.

The record 3 of measurement data can be selected in step 180 for the initial labeling or for re-labeling with a target output.

The output 4 ascertained for the record 3 by the task network 1 can be discarded in step 190.

A technical system 50, which uses the output 4 supplied by the task network 1, can be controlled in step 200 to prevent disadvantageous consequences of incorrect outputs 4.

A vehicle 51 and/or a robot 52, for example, can in particular be selected as a technical system 50 and controlled in such a way that
at least one additional physical sensor is activated for the observation of the surroundings of the robot 52 and/or vehicle 51 (block 201); and/or
the travel speed of an at least partially automated robot 52 and/or vehicle 51 is reduced (block 202); and/or
a driver assistance system and/or a system for the at least partially automated guidance of the robot 52 and/or vehicle 51 is completely or partially deactivated (block 203), and/or
a robot 52, or an at least partially automated vehicle 51, is brought to a standstill on a pre-planned emergency stop trajectory (block 204).

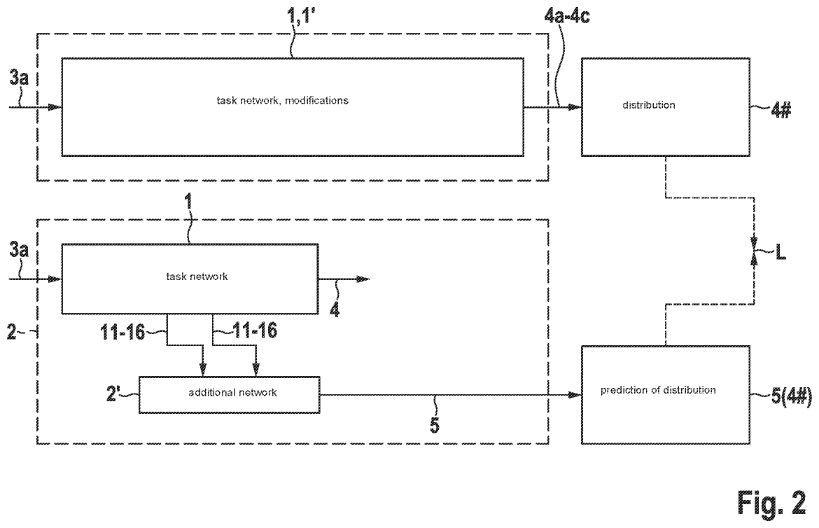

FIG. 2 illustrates how the measurement network 2 can be operated with the further use of intermediate results (here: feature maps 11-16) worked out in the task network 1. FIG. 2 shows in particular the training of the measurement network 2 using training records 3a.

Each training record 3a is fed to modifications 1′ of the task network 1, so that a plurality of different outputs 4a-4c is created. These outputs 4a-4c form a distribution 4 #.

Each training record 3a is also fed to the measurement network 2 that is to be trained. In the example shown in FIG. 2, the measurement network 2 picks up intermediate results (here: feature maps 11-16) which arise in the task network 1 during the processing of the training records 3a into outputs 4. The intermediate results (feature maps 11-16) are fed to an additional network 2′, which is part of the measurement network 2 and considerably smaller than the task network 1. The additional network 2′ maps onto a prediction 5 of the distribution 4 #the feature maps 11-16 which have emerged from the training record 3a. A cost function (loss function L) evaluates deviations of the prediction 5 from the distribution 4 #ascertained with modifications 1′ of the task network 1.

FIG. 3 illustrates the further use of the feature maps 11-16 produced in a feature extractor 1 #of the task network 1. The additional network 2′ in the measurement network 2 and shown in FIG. 2 comprises three sub-networks 21-23 in the example shown in FIG. 3. These sub-networks 21-23 receive different combinations of feature maps 11-16, which are in each case created by stringing together (concatenating) the corresponding feature maps 11-16, symbolized by the operator ⊕. Each of the sub-networks 21-23 provides its own contribution to the prediction 5 of the distribution 4 #. Since the feature maps 11-16 relate to different size scales, the contributions of the sub-networks 21-23 also relate to different size scales, here ⅛, 1/16, and 1/32.

In the task network 1 itself, the feature maps 11-16 from the feature extractor 1 #in the task header 1 ##are processed into the output 4 of the task network.

What is claimed is:

1. A method for training a measurement network which ascertains an uncertainty of an already trained task network during processing of a record of measurement data into outputs with regard to a predefined task, the task network being a deterministic task network or a probabilistic task network, the method comprising the steps:
feeding each training record of measurement data from a training data: (i) to a plurality of modifications of the deterministic task network, or (ii) multiple times to the probabilistic task network, wherein the training record is thus mapped onto a plurality of outputs;
feeding each training record to the measurement network and mapping the training record onto a prediction of a distribution of the plurality of outputs, wherein a processing chain of the measurement network includes a part of a processing chain of the task network;
evaulating, using a predefined cost function, an extent to which the prediction of the distribution is consistent with the plurality of outputs; and
optimizing network parameters which characterize a behavior of that part of the measurement network that does not belong to the processing chain of the task network, the optimizing being with an aim of the evaluation being improved by the cost function during further processing of training records.

2. The method according to claim 1, wherein:
a convolutional neural network with one or more convolutional layers that process their input by sliding application of one or more filter kernels to feature maps is selected as the task network, and
the measurement network processes one or more of the feature maps into the prediction of the distribution.

3. The method according to claim 2, wherein the measurement network includes a plurality of sub-networks which process different feature maps or combinations of feature maps.

4. The method according to claim 1, wherein
the deterministic task network is selected as the task network, and
the modifications of the deterministic task network leave unchanged that part of the determinstic task network which is contained in the processing chain of the measurement network.

5. The method according to claim 1, wherein the task network is the deterministic task network, and the modifications of the deterministic task network are generated by deactivating a randomly drawn selection of neurons or other processing units of the deterministic task network.

6. The method according to claim 1, wherein:
a predefined distribution function whose behavior is characterized by distribution parameters is adapted by optimizing the distribution parameters to the plurality of outputs, and
the measurement network ascertains a prediction of the distribution parameters.

7. The method according to claim 6, wherein the distribution function is a Dirichlet distribution.

8. The method according to claim 1, wherein:
records of measurement data are fed to the trained measurement network, and
the uncertainty is ascertained from the prediction of the distribution supplied for each record by the measurement network during the processing of the record.

9. The method according to claim 8, wherein the uncertainty is ascertained from at least one distribution parameter and/or from at least one statistical characteristic variable of the distribution predicted by the measurement network.

10. The method according to claim 8, wherein the uncertainty is ascertained based on a plurality of samples drawn from the distribution predicted by the measurement network.

11. The method according to claim 8, wherein in response to the ascertained uncertainty meeting a predefined criterion:
the record is selected from measurement data for initial labeling or for re-labeling with a target output, and/or
the output ascertained for the record by the task network is discarded, and/or
a technical system which uses the output supplied by the task network is controlled to prevent disadvantageous consequences of incorrect outputs.

12. The method according to claim 11, wherein the technical system is a vehicle and/or a robot which is controlled in such a way that:
at least one additional physical sensor is activated for observation of surroundings of the vehicle and/or the robot; and/or
the vehicle and/or the robot is at least partially automated and a travel speed of the vehicle and/or the robot is reduced; and/or
a driver assistance system and/or a system for the at least partially automated guidance of the vehicle and/or the robot is completely or partially deactivated, and/or
the vehicle and/or the robot is brought to a standstill on a pre-planned emergency stop trajectory.

13. The method according to claim 1, wherein an image classifier which maps an input image as a record of measurement data onto classification scores with respect to one or more classes of a predefined classification is selected as the task network.

14. A non-transitory machine-readable data carrier on which is stored a computer program including machine-readable instructions for training a measurement network which ascertains an uncertainty of an already trained task network during processing of a record of measurement data into outputs with regard to a predefined task, the task network being a deterministic task network or a probabilistic task network, the instructions, when executed by one or more computers and/or compute instances, cause the one or more computers and/or compute instances to perform the following steps:
feeding each training record of measurement data from a training data: (i) to a plurality of modifications of the deterministic task network, or (ii) multiple times to the probabilistic task network, wherein the training record is thus mapped onto a plurality of outputs;
feeding each training record to the measurement network and mapping the training record onto a prediction of a distribution of the plurality of outputs, wherein a processing chain of the measurement network includes a part of a processing chain of the task network;
evaulating, using a predefined cost function, an extent to which the prediction of the distribution is consistent with the plurality of outputs; and
optimizing network parameters which characterize a behavior of that part of the measurement network that does not belong to the processing chain of the task network, the optimizing being with an aim of the evaluation being improved by the cost function during further processing of training records.

15. One or more computer and/or compute instances including a non-transitory machine-readable data carrier on which is stored a computer program including machine-readable instructions for training a measurement network which ascertains an uncertainty of an already trained task network during processing of a record of measurement data into outputs with regard to a predefined task, the task network being a deterministic task network or a probabilistic task network, the instructions, when executed by the one or more computers and/or compute instances, cause the one or more computers and/or compute instances to perform the following steps:
feeding each training record of measurement data from a training data: (i) to a plurality of modifications of the deterministic task network, or (ii) multiple times to the probabilistic task network, wherein the training record is thus mapped onto a plurality of outputs;
feeding each training record to the measurement network and mapping the training record onto a prediction of a distribution of the plurality of outputs, wherein a processing chain of the measurement network includes a part of a processing chain of the task network;
evaulating, using a predefined cost function, an extent to which the prediction of the distribution is consistent with the plurality of outputs; and
optimizing network parameters which characterize a behavior of that part of the measurement network that does not belong to the processing chain of the task network, the optimizing being with an aim of the evaluation being improved by the cost function during further processing of training records.
